(19) United States
(12) Patent Application Publication
(10) Pub. No.: US 2018/0093371 A1
(43) Pub. Date: Apr. 5, 2018

(54) Stapler structure

(71) Applicant: Jui-Chen CHANG, Taipei City (TW)

(72) Inventor: Jui-Chen CHANG, Taipei City (TW)

(21) Appl. No.: 15/284,545

(22) Filed: Oct. 4, 2016

(51) Int. Cl. B25C 5/02

(52) U.S. Cl. CPC B25C 5/025

(57) ABSTRACT

A stapler structure contains: a base, a stapling mechanism and a press block which are connected with a connector. The stapling mechanism includes an elastic sheet and a trigger portion accommodating a control column which has a horizontal stein. An accommodation seat connects with a rotation member and a guiding groove having a through trough, and the accommodation seat houses a locking sheet having two raised ribs, and a coupling plate is joined with the accommodation seat and has a recess. The rotation member has a hollow chamber, an elongated orifice, and multiple fixing orifices. A movable adjuster has a first protrusion and a coupling shaft configured to connect a second protrusion with the first protrusion, a first positioning post is inserted into the elongated orifice, a second compression spring is accommodated in the hollow chamber, and a C retaining ring retains with the second compression spring.

### FIELD OF THE INVENTION

The present invention relates to a stapler structure which accommodates a ruler easily and adjusts a desired stapling position quickly.

### BACKGROUND OF THE INVENTION

Referring to FIG. 1, a conventional stapler contains: a base 1, a ruler 2, and a stapling mechanism 3. The base 1 includes an abutting section 4 arranged on a bottom thereof and an extending arm 5 extending upwardly from a top of the abutting section 4. The abutting section 4 is fixed on a desk, and the ruler 2 is in connection with a free end of the abutting section 4. The stapling mechanism 3 is coupled with a free end of the extending arm 5 and includes an outlet 6 defined one end thereof corresponding to a notch 7 of the ruler 2.

However, as stapling a peripheral side of a paper, the ruler 2 is unnecessary and cannot be removed. Furthermore, a distance between the abutting section 4 and the extending arm 5 is too long to reduce a size of the conventional stapler.

The present invention has arisen to mitigate and/or obviate the afore-described disadvantages.

### SUMMARY OF THE INVENTION

The primary objective of the present invention is to provide a stapler structure which accommodates a ruler easily and adjusts a desired stapling position quickly.

To obtain above-mentioned objective, a stapler structure provided by the present invention contains: a base, a stapling mechanism, and a press block.

A rear end of each of the stapling mechanism and the press block is in connection with a connector on a rear end of the base, and the stapling mechanism includes an elastic sheet disposed on a bottom thereof.

The stapling mechanism also includes a trigger portion arranged on a front end thereof and accommodating a control column, and the control column fits with a first compression spring and has a horizontal stein laterally extending from a top of the control column, wherein the horizontal stein has a slot defined on a bottom thereof, and the first compression spring abuts against the slot and a top of the trigger portion, two ends of the horizontal stein retain with two holders on two front sides of an interior of the press block, respectively, and two bearings fit with the two ends of the horizontal stein.

An accommodation seat is formed on a front end of the base and a rear end of the accommodation seat connects with a rotation member, the accommodation seat has a guiding groove defined on a front end thereof, and the guiding groove has a through trough formed in a central portion thereof, wherein the accommodation seat houses a locking sheet which abuts against an insertion on a front end of the rotation member and is locked by at least one screw bolt, such that the locking sheet and the rotation member are in connection with the accommodation seat, wherein the locking sheet has two raised ribs arranged on a front end thereof and extending out of the through trough of the guiding groove, and a coupling plate is joined with the accommodation seat and has a recess defined on a top thereof.

The rotation member is in a U shape and has a hollow chamber defined on a central portion thereof, an elongated orifice formed on a central portion of a top thereof, and multiple fixing orifices parallelly arranged beside two sides of the elongated orifice.

A movable adjuster is mounted on the top of the rotation member, and the movable adjuster has a first protrusion extending outwardly from a front end thereof and has a coupling shaft configured to connect a second protrusion with the first protrusion, wherein a first positioning post is inserted into the elongated orifice via the second protrusion, a second compression spring is accommodated in the hollow chamber, and a C retaining ring retains with a bottom of the second compression spring, wherein two second positioning posts selectively extend into two opposite of the multiple fixing orifices via a bottom of the second protrusion.

### BRIEF DESCRIPTION OF THE DRAWINGS

FIG. 1 is a perspective view of a conventional stapler.

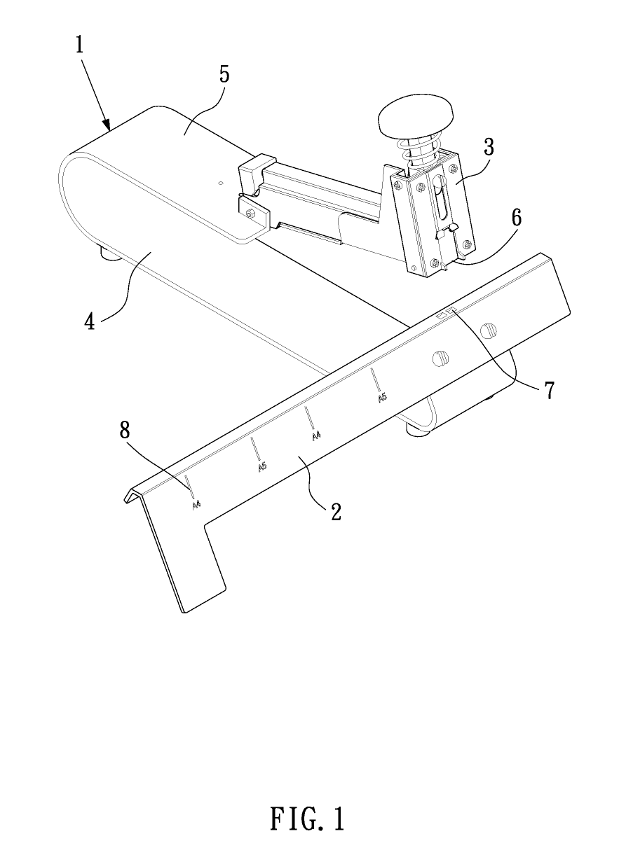

FIG. 2 is a perspective view showing the assembly of a stapler structure according to a preferred embodiment of the present invention.

FIG. 3 is a perspective view showing the exploded components of the stapler structure according to the preferred embodiment of the present invention.

FIG. 4 is another perspective view showing the assembly of the stapler structure according to the preferred embodiment of the present invention.

FIG. 5 is a cross sectional view showing the assembly of the stapler structure according to the preferred embodiment of the present invention.

FIG. 6 is a cross sectional view showing the assembly of a part of the stapler structure according to the preferred embodiment of the present invention.

FIG. 7 is another cross sectional view showing the assembly of a part of the stapler structure according to the preferred embodiment of the present invention.

FIG. 8 is also another cross sectional view showing the assembly of a part of the stapler structure according to the preferred embodiment of the present invention.

FIG. 9 is a side plane view showing the operation of a part of the stapler structure according to the preferred embodiment of the present invention.

FIG. 10 is another side plane view showing the operation of a part of the stapler structure according to the preferred embodiment of the present invention.

### DETAILED DESCRIPTION OF THE PREFERRED EMBODIMENTS

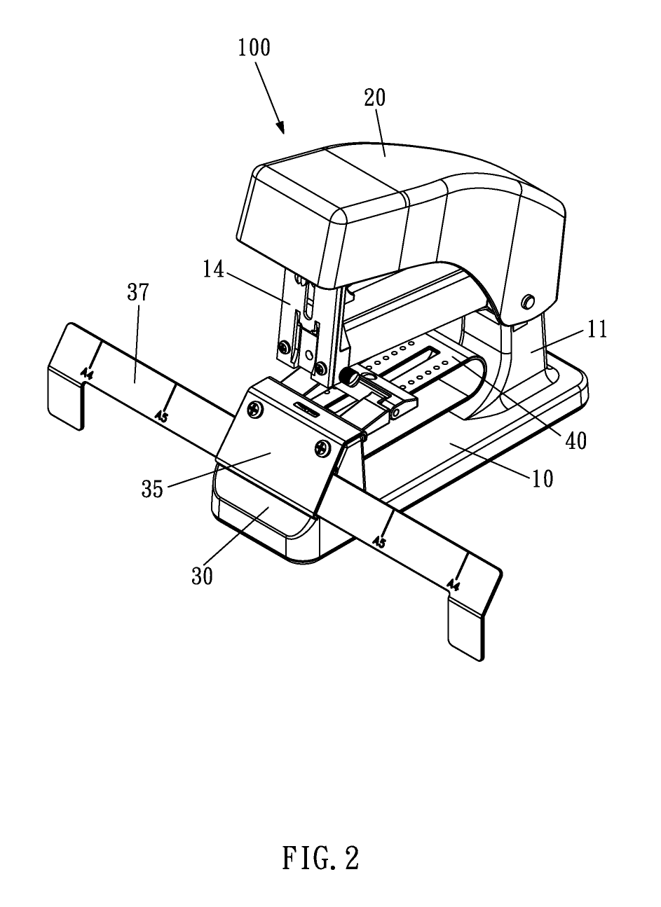

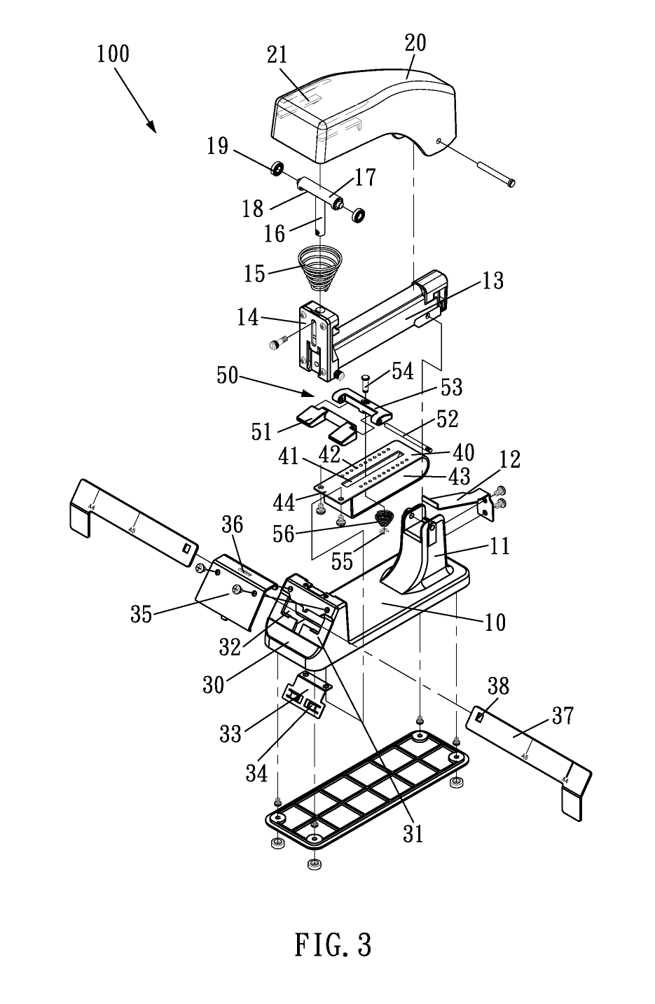

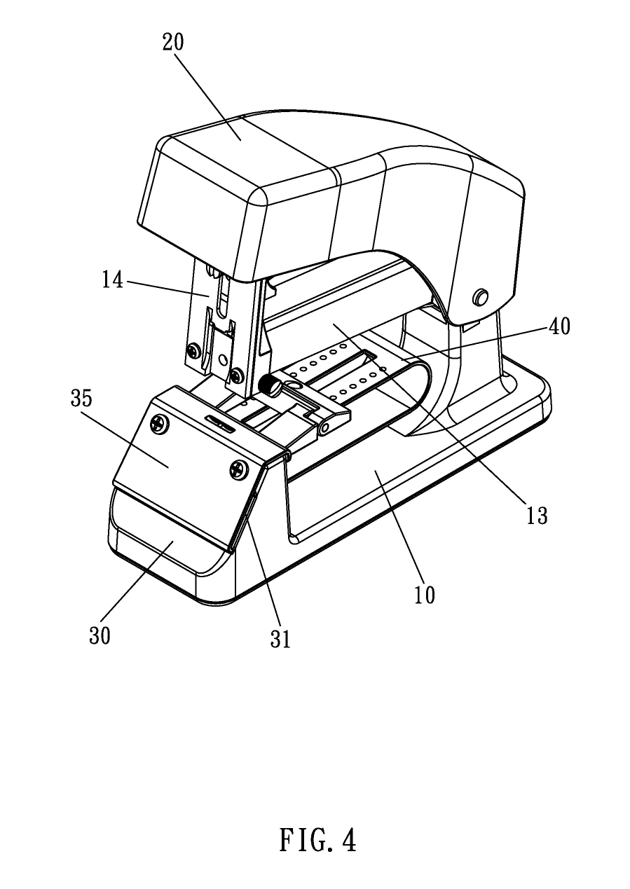

With reference to FIGS. 2 to 5, a stapler structure 100 according to a preferred embodiment of the present invention comprises: a base 10, a stapling mechanism 13, and a press block 20. A rear end of each of the stapling mechanism 13 and the press block 20 is in connection with a connector 11 on a rear end of the base 10, and the stapling mechanism 13 includes an elastic sheet 12 disposed on a bottom thereof. The stapling mechanism 13 also includes a trigger portion 14 arranged on a front end thereof and accommodating a control column 16, wherein the control column 16 fits with a first compression spring 15 and has a horizontal stein 17 laterally extending from a top of the control column 16, wherein the horizontal stein 17 has a slot 18 defined on a bottom thereof, and the first compression spring 15 abuts against the slot 18 and a top of the trigger portion 14, two ends of the horizontal stein 17 retain with two holders 21 on two front sides of an interior of the press block 20, respectively, and two bearings 19 fit with the two ends of the horizontal stein 17.

An accommodation seat 30 is formed on a front end of the base 10 and a rear end of the accommodation seat 30 connects with a rotation member 40. The accommodation seat 30 has a guiding groove 31 defined on a front end thereof, and the guiding groove 31 has a through trough 32 formed in a central portion thereof, wherein the accommodation seat 30 houses a locking sheet 33 which abuts against an insertion 44 on a front end of the rotation member 40 and is locked by at least one screw bolt, such that the locking sheet 33 and the rotation member 40 are in connection with the accommodation seat 30. Furthermore, the locking sheet 33 has two raised ribs 34 arranged on a front end thereof and extending out of the through trough 32 of the guiding groove 31, and a coupling plate 35 is joined with the accommodation seat 30 and has a recess 36 defined on a top thereof.

The rotation member 40 is in a U shape and has a hollow chamber 43 defined on a central portion thereof, an elongated orifice 41 formed on a central portion of a top thereof, and multiple fixing orifices 42 parallelly arranged beside two sides of the elongated orifice 41.

A movable adjuster 50 is mounted on the top of the rotation member 40, and the movable adjuster 50 has a first protrusion 51 extending outwardly from a front end thereof and has a coupling shaft 52 configured to connect a second protrusion 53 with the first protrusion 51, such that the first protrusion 51 rotates upwardly or downwardly along the coupling shaft 52. A first positioning post 54 is inserted into the elongated orifice 41 via the second protrusion 53, a second compression spring 56 is accommodated in the hollow chamber 43, and a C retaining ring 55 retains with a bottom of the second compression spring 56. In addition, two second positioning posts 57 selectively extend into two opposite of the multiple fixing orifices 42 via a bottom of the second protrusion 53.

Referring further to FIGS. 2 to 4, a ruler 27 is housed in the guiding groove 31 of the accommodation seat 30 and has an opening 38 configured to retain with the two raised ribs 34.

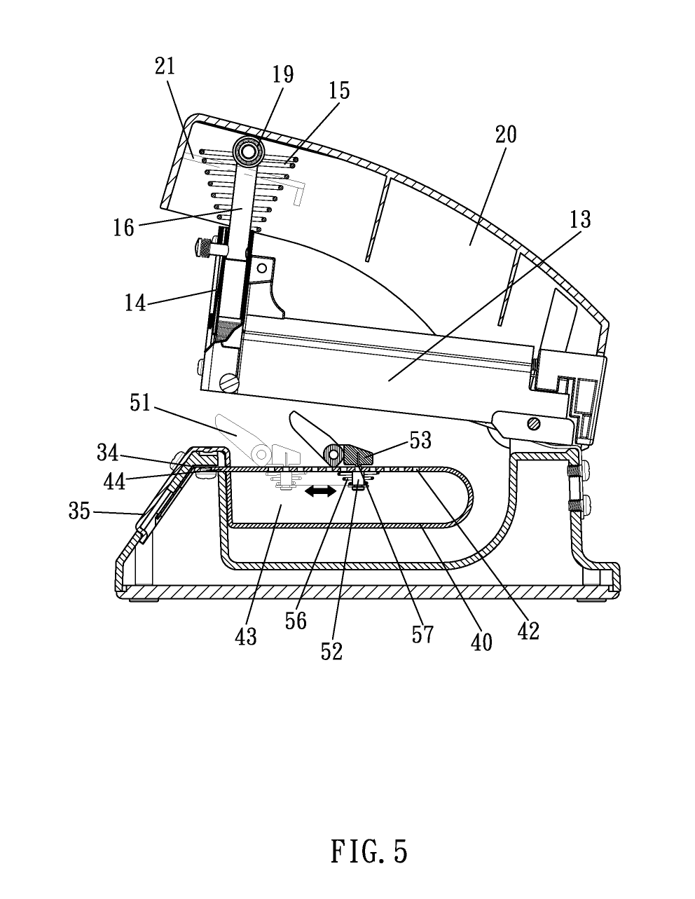

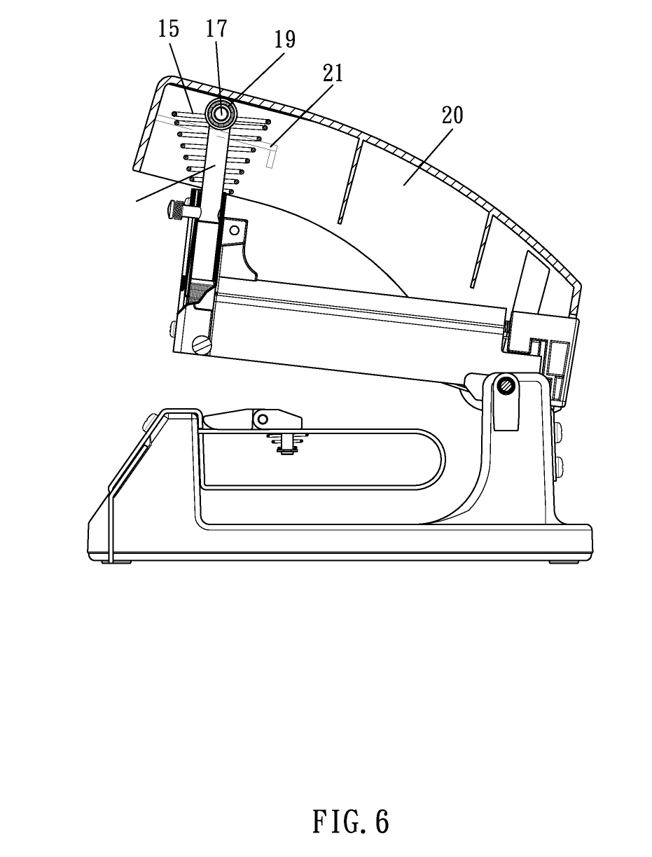

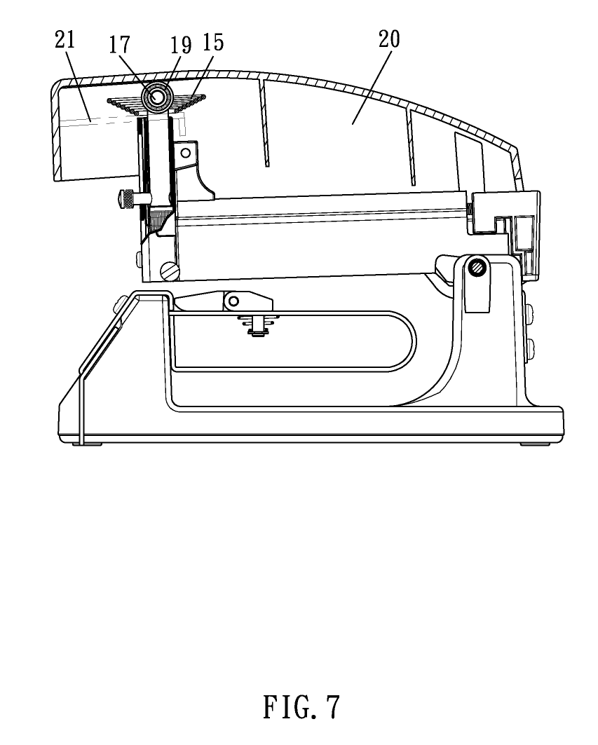

As shown in FIGS. 5 to 7, the press block 20 is pressed so that the horizontal stein 17 rotates on the two holders 21 by way of the two bearings 19, and the control column 16 is driven by the horizontal stein 17 to actuate the trigger portion 14, wherein when the horizontal stein 17 presses downwardly, the first compression spring 15 is accommodated in the slot 18, hence the press block 20 moves upwardly to an original position.

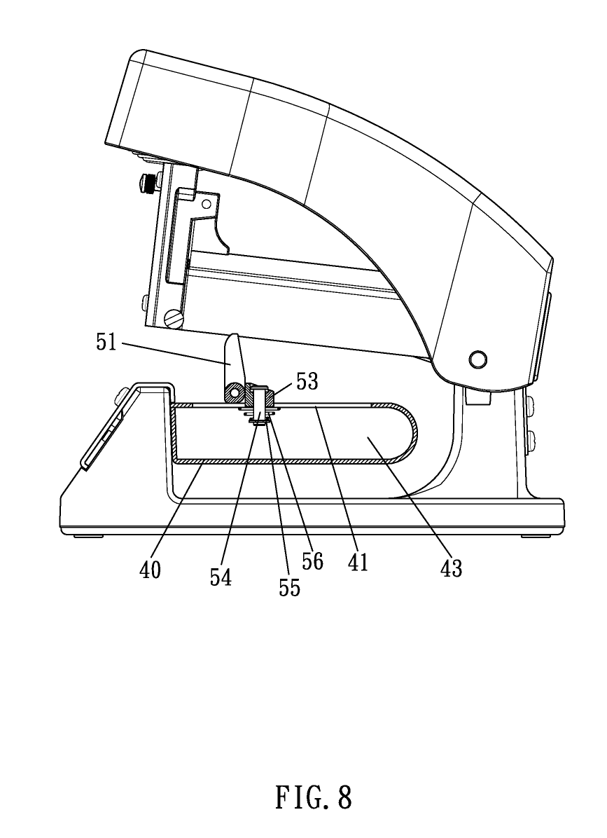

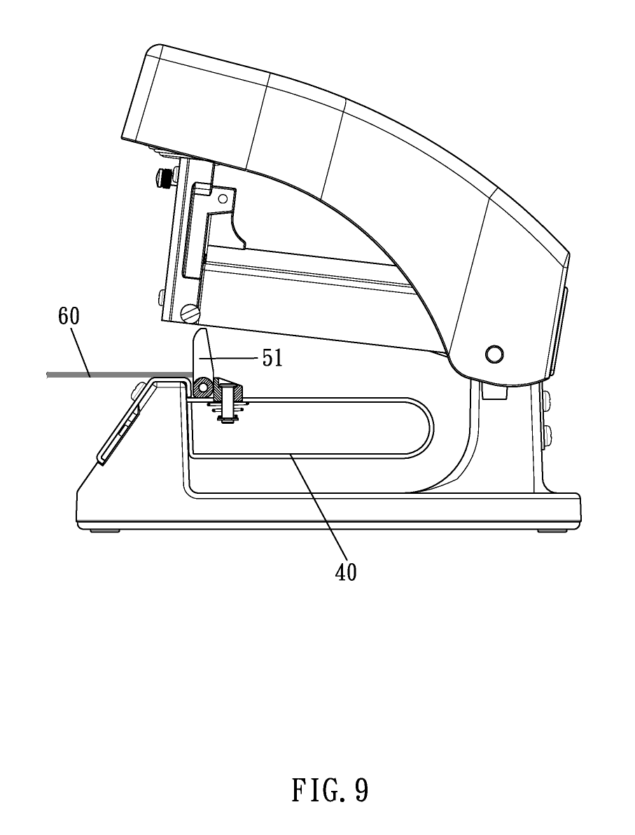

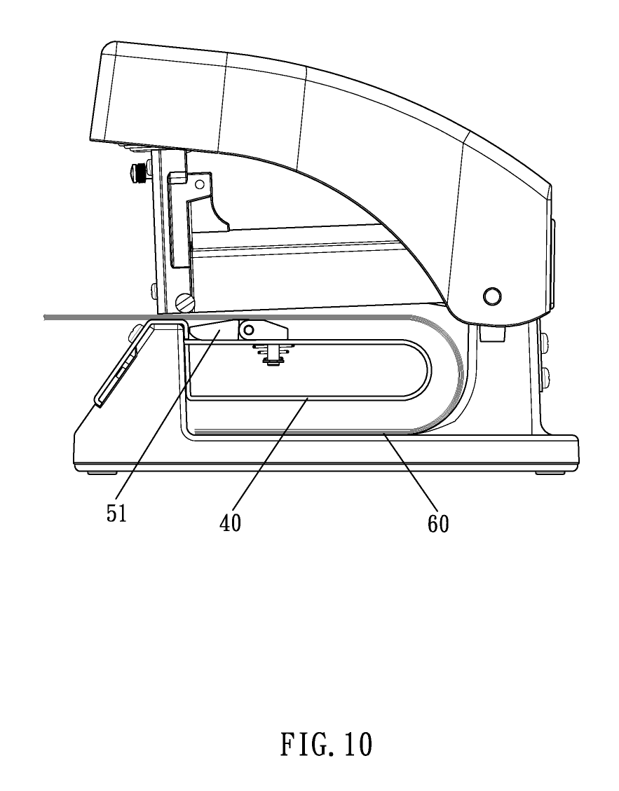

As illustrated in FIGS. 5 and 8-10, when the first protrusion 51 of the movable adjuster 50 rotates 45 degrees, it pushes the second protrusion 53 upwardly so that the two second positioning posts 57 remove from said two opposite fixing orifices 42 of the rotation member 40, and the movable adjuster 50 is moved toward a desired position of the elongated orifice 41, then the first protrusion 51 is rotated upwardly or downwardly so that the two second positioning posts 57 extend into said two opposite fixing orifices 42, thus fixing the movable adjuster 50.

As stapling a peripheral side of a paper 60, the first protrusion 51 is rotated upwardly so as to stop the paper 60. As desiring to staple a central position of the paper 60, the movable adjuster 50 is moved backwardly and the first protrusion 51 is pressed downwardly so that the paper 60 moves to locate under a bottom of the rotation member 40, thus stapling the central position of the paper 60.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A stapler structure comprising: a base, a stapling mechanism, and a press block;
wherein a rear end of each of the stapling mechanism and the press block is in connection with a connector on a rear end of the base, and the stapling mechanism includes an elastic sheet disposed on a bottom thereof;
wherein the stapling mechanism also includes a trigger portion arranged on a front end thereof and accommodating a control column, and the control column fits with a first compression spring and has a horizontal stein laterally extending from a top of the control column, wherein the horizontal stein has a slot defined on a bottom thereof, and the first compression spring abuts against the slot and a top of the trigger portion, two ends of the horizontal stein retain with two holders on two front sides of an interior of the press block, respectively, and two bearings fit with the two ends of the horizontal stein;
wherein an accommodation seat is formed on a front end of the base and a rear end of the accommodation seat connects with a rotation member, the accommodation seat has a guiding groove defined on a front end thereof, and the guiding groove has a through trough formed in a central portion thereof, wherein the accommodation seat houses a locking sheet which abuts against an insertion on a front end of the rotation member and is locked by at least one screw bolt, such that the locking sheet and the rotation member are in connection with the accommodation seat, wherein the locking sheet has two raised ribs arranged on a front end thereof and extending out of the through trough of the guiding groove, and a coupling plate is joined with the accommodation seat and has a recess defined on a top thereof;
wherein the rotation member is in a U shape and has a hollow chamber defined on a central portion thereof, an elongated orifice formed on a central portion of a top thereof, and multiple fixing orifices parallelly arranged beside two sides of the elongated orifice;
wherein a movable adjuster is mounted on the top of the rotation member, and the movable adjuster has a first protrusion extending outwardly from a front end thereof and has a coupling shaft configured to connect a second protrusion with the first protrusion, wherein a first positioning post is inserted into the elongated orifice via the second protrusion, a second compression spring is accommodated in the hollow chamber, and a C retaining ring retains with a bottom of the second compression spring, wherein two second positioning posts selectively extend into two opposite of the multiple fixing orifices via a bottom of the second protrusion.

2. The stapler structure as claimed in claim 1, wherein a ruler is housed in the guiding groove of the accommodation seat and has an opening configured to retain with the two raised ribs.

3. The stapler structure as claimed in claim 1, wherein the press block is pressed so that the horizontal stein rotates on the two holders by way of the two bearings, and the control column is driven by the horizontal stein to actuate the trigger portion, wherein when the horizontal stein presses downwardly, the first compression spring is accommodated in the slot, hence the press block moves upwardly to an original position.

4. The stapler structure as claimed in claim 1, wherein the first protrusion rotates upwardly or downwardly along the coupling shaft.

5. The stapler structure as claimed in claim 1, wherein when the first protrusion of the movable adjuster rotates degrees, the first protrusion pushes the second protrusion upwardly so that the two second positioning posts remove from said two opposite fixing orifices of the rotation member, and the movable adjuster is moved toward a desired position of the elongated orifice, then the first protrusion is rotated upwardly or downwardly so that the two second positioning posts extend into said two opposite fixing orifices, thus fixing the movable adjuster.
